(19) United States
(12) Patent Application Publication
(10) Pub. No.: US 2011/0101158 A1
(43) Pub. Date: May 5, 2011

(54) Thrust Reversers Including Monolithic Components

(75) Inventors: John M. Welch, Wichita, KS (US); Thomas D. Popp, Wichita, KS (US); Brian R. Kitt, Wichita, KS (US); Christopher S. Sawyer, Oxford, KS (US)

(73) Assignee: The Boeing Company, Chicago, IL (US)

(21) Appl. No.: 11/773,488

(22) Filed: Jul. 5, 2007

Related U.S. Application Data
(63) Continuation-in-part of application No. 10/907,320, filed on Mar. 29, 2005, now Pat. No. 7,571,527.
(60) Provisional application No. 60/819,230, filed on Jul. 6, 2006.

(51) Int. Cl. F02K 1/64

(52) U.S. Cl. 244/110 B

(57) ABSTRACT

Aircraft systems including thrust reversers with monolithic components are described herein. An aircraft system in accordance with one embodiment includes a thrust reverser having a fan duct inner wall section, a fan duct outer wall section radially outward of the fan duct inner wall section, and a connecting wall section extending between the fan duct inner wall section and the fan duct outer wall section. The fan duct inner wall section, the fan duct outer wall section, and the connecting wall section form a monolithic member.

### CROSS-REFERENCE TO RELATED APPLICATION

This application is a continuation-in-part of U.S. patent application Ser. No. 10/907,320, filed Mar. 29, 2005, and claims priority to Provisional Application No. 60/819,230, filed on Jul. 6, 2006 and incorporated herein by reference.

### TECHNICAL FIELD

The present application is related to thrust reversers having monolithic components. For example, in several embodiments, a thrust reverser can include a fan duct inner wall section and a fan duct outer wall section that together form a single monolithic member. In other embodiments, a thrust reverser can include an outer cowling section and a fan duct outer wall section that together form a monolithic member.

### BACKGROUND

Jet aircraft, such as commercial passenger and military aircraft, include nacelles for housing the jet engines. The nacelles couple the engines to engine pylons and in turn to the wings and include thrust reversers to reduce the speed of the aircraft after landing. Conventional thrust reversers include a translating outer cowling, a fan duct outer wall radially inward of the cowling, and a fan duct inner wall radially inward of the outer wall. The fan duct outer and inner walls define a nozzle through which fan gas flows to produce forward thrust. Conventional thrust reversers further include a blocker door and cascades (i.e., a plurality of guide vanes) positioned between the translating cowling and the fan duct outer wall. The blocker door is movable between a stowed position and a deployed position, and the translating cowling and the fan duct outer wall are movable as a unit between a stowed position and a deployed position. As the fan duct outer wall moves to the deployed position, a drag link pulls the blocker door to the deployed position. In the deployed position, the cowling and the fan duct outer wall are positioned aft of the cascades so that the cascades are exposed to gas flow in the nozzle and the ambient environment. When the translating cowling, the fan duct outer wall, and the blocker door are in the deployed position, the blocker door obstructs gas flow through the nozzle so that at least a portion of the flow is diverted radially outward through the cascades to generate reverse thrust.

Conventional translating cowlings, fan duct outer walls, and fan duct inner walls are each fabricated separately and then subsequently assembled to construct a thrust reverser. Accordingly, different sets of tools are used to construct each component. One drawback of conventional thrust reversers is that multiple families of expensive tools are required to construct the thrust reversers. Another drawback of conventional thrust reversers is that they require large actuators and tracks for moving the translating cowlings and the fan duct outer walls between the stowed and deployed positions. The actuators and tracks are heavy and require significant space within the nacelle. Typically, the tracks project from the cowling and so the nacelle includes a fairing to enclose the tracks. The track fairing and the weight of the components reduces the performance of the aircraft nacelle. Therefore, a need exists to reduce the cost and weight of thrust reversers.

### SUMMARY

Several aspects of the disclosure are directed to aircraft systems including thrust reversers. An aircraft system in accordance with one embodiment includes a thrust reverser having a fan duct inner wall section, a fan duct outer wall section positioned radially outward of the fan duct inner wall section, and a connecting wall section extending between the fan duct inner wall section and the fan duct outer wall section. The fan duct inner wall section, the fan duct outer wall section, and the connecting wall section form a single, continuous monolithic member. In several applications, the thrust reverser may be configured to operate without a drag link extending between the fan duct inner and outer wall sections.

In another embodiment, an aircraft system includes a thrust reverser having a first portion and a section portion positioned proximate to the first portion. The first portion includes (a) a first outer cowling section, (b) a first fan duct outer wall section positioned radially inward of the first outer cowling section, and (c) a first fan duct inner wall section positioned radially inward of the first fan duct outer wall section. The first outer cowling section, the first fan duct outer wall section, and the first fan duct inner wall section form a first monolithic member. The second portion includes (a) a second outer cowling section, (b) a second fan duct outer wall section positioned radially inward of the second outer cowling section, and (c) a second fan duct inner wall section positioned radially inward of the second fan duct outer wall section. The second outer cowling section, the second fan duct outer wall section, and the second fan duct inner wall section form a second monolithic member separate from the first monolithic member.

In another embodiment, an aircraft system includes a thrust reverser having a non-translating outer cowling section and a fan duct outer wall section positioned radially inward of the outer cowling section. The outer cowling section and the fan duct outer wall section form a monolithic member. In several applications, the thrust reverser is configured to operate without cascades positioned between the fan duct outer wall section and the non-translating outer cowling section.

### BRIEF DESCRIPTION OF THE DRAWINGS

FIG. 1 illustrates a perspective view of a mandrel in accordance with one embodiment of the disclosure.

FIG. 2 illustrates an exploded perspective view of the body sections and nozzle section of the mandrel.

FIG. 3 illustrates a bottom view of the second fairing bar.

FIG. 4 illustrates the first fairing bar including the ball roller assembly attached to the tilting plate.

FIG. 5 illustrates the ball roller assembly.

FIG. 6 illustrates a perspective view of the mandrel including the third fairing bar and the cavity section.

FIG. 7 illustrates the attachment of the first outer section to the first fairing bar.

FIG. 8 illustrates the attachment of the second outer section to the first fairing bar.

FIG. 9 illustrates the attachment of the center section to the first and second outer sections.

FIG. 10 illustrates the roller ball track plate.

FIG. 11 illustrates a perspective view of the tilting plate assembly.

FIG. 12 illustrates a top view of the tilting plate assembly.

FIG. 13 illustrates a side view of the tilting plate assembly.

FIG. 14 illustrates the mandrel coming out of the part.

FIG. 15 illustrates one method of constructing a mandrel for fabrication of a monolithic composite nacelle.

FIG. 16 illustrates one method of assembling a body section of the mandrel.

FIG. 17 illustrates one method of stretch forming a metallic skin over Stretch Form Blocks representing the egg crate structure.

FIG. 18 illustrates one method of assembling a mandrel for fabrication of a monolithic composite nacelle.

FIG. 19 illustrates one method of disassembling the first mandrel.

FIG. 20 illustrates one method of assembling the second mandrel.

FIG. 21 illustrates one method of disassembling the second mandrel.

FIGS. 22-25B illustrate several embodiments of thrust reverser components in accordance with the disclosure.

FIG. 22 is an isometric view of a thrust reverser portion in accordance with one embodiment of the disclosure.

FIG. 23 is a schematic side cross-sectional view of the thrust reverser portion taken substantially along the line A-A of FIG. 22.

FIG. 24A is a schematic side cross-sectional view of a thrust reverser portion in accordance with another embodiment of the disclosure.

FIG. 24B is a schematic side cross-sectional view of the thrust reverser portion illustrated in FIG. 24A with the doors open.

FIG. 25A is a schematic front view of a thrust reverser in accordance with one embodiment of the disclosure.

FIG. 25B is a schematic front view of the thrust reverser illustrated in FIG. 25A with the thrust reverser deployed.

### DETAILED DESCRIPTION

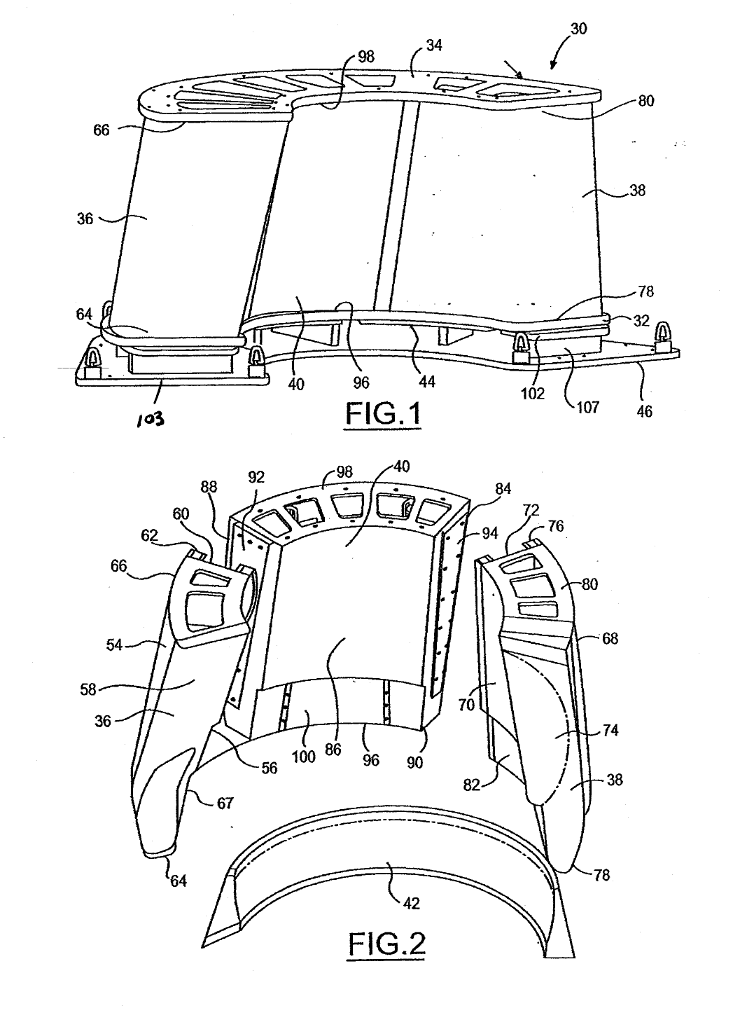

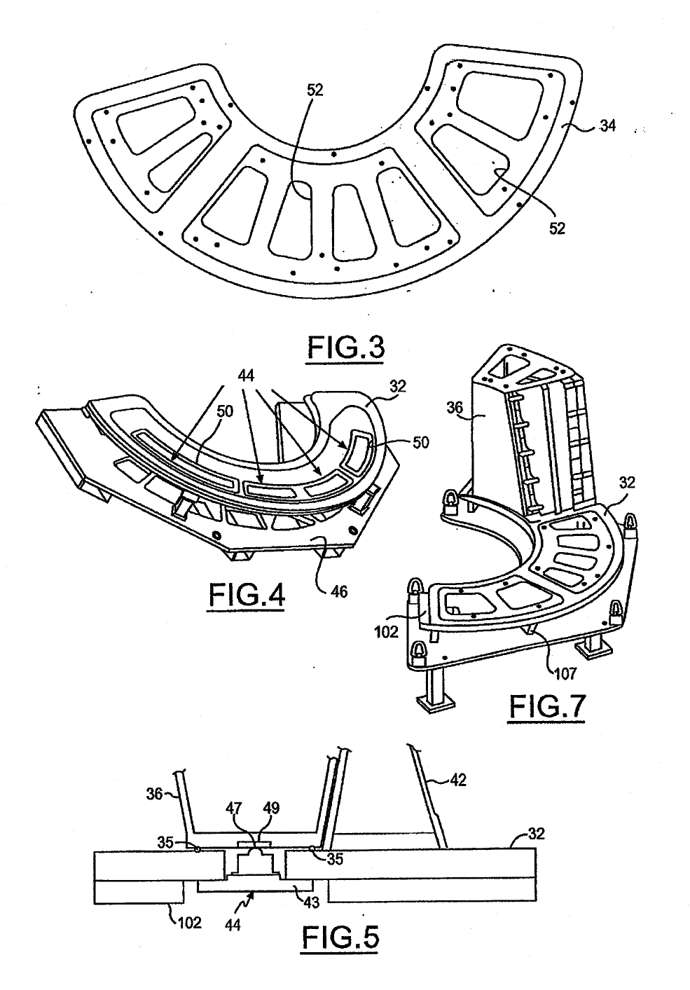

The following disclosure describes aircraft systems having thrust reversers with monolithic components. Monolithic as used herein means formed as a single piece, and not formed by assembling together several discrete parts that were constructed separately. Accordingly, monolithic structures typically are not readily disassemblable into separate parts that can be reassembled. Certain details are set forth in the following description and in FIGS. 1-25B to provide a thorough understanding of various embodiments of the disclosure. Other details describing well-known structures and systems often associated with thrust reversers are not set forth in the following disclosure to avoid unnecessarily obscuring the description of various embodiments. Many of the details, dimensions, angles, and other features shown in the figures are merely illustrative of particular embodiments of the disclosure. Accordingly, additional embodiments can have other details, dimensions, and/or features without departing from the present disclosure. In addition, other embodiments of the disclosure may be practiced without several of the details described below, or various aspects of any of the embodiments described below can be combined in different combinations.

### A. Embodiments of Mandrels for Forming Sections of a Thrust Reverser

FIGS. 1-6 illustrate one embodiment of a mandrel 30. It should be noted that the terms mandrel and tool are used interchangeably. The illustrated mandrel 30 includes two fairing bars 32, 34, three body sections 36, 38, 40, a nozzle section 42, a ball roller assembly 44, a tilting plate assembly 46, and a cavity section 48. The first fairing bar 32 has a generally flat, arch shape and includes at least two radially located apertures 50. Similarly, the second fairing bar 34 has a generally flat, arch shape and is positioned parallel to the first fairing bar 32. In one embodiment, the second fairing bar 34 also includes at least two radially located apertures 52.

The three body sections include a first outer section 36, a second outer section 38 and a center section 40. The first outer section 36 has a generally arch-shaped cross section. The sidewalls of the first outer section 36 include an outer wall 54, an inner wall 56, a first sidewall 58 and a second sidewall 60. The second sidewall 60 includes a first female dovetail attachment 62 for engagement with the center section 40. The outer and inner walls 54, 56 each abut the first sidewall 58 and the second sidewall 60 but do not abut each other. Further, the first outer section 36 has a first end 64 and a second end 66. Both the first and second ends 64, 66 abut the outer wall 54, the inner wall 56, the first sidewall 58 and the second sidewall 60. There is a notched area 67 in the inner wall 56 of the first outer section 36 near the first end 64. Further, the first outer section 36 has a tapered contour. In other words, the second end 66 has a larger cross sectional area than the first end 64 of the first outer section 36. It can be appreciated, that in general, fan duct contours, to which the mandrel is designed, have an entrance that is larger than the fan duct exit, or nozzle end.

As illustrated in FIG. 1, when the mandrel 30 is assembled, the first outer section 36 is positioned between and attached to the first fairing bar 32 and the second fairing bar 34. The arch shape of the first outer section 36 generally aligns with the arch shape of the first and second fairing bars 32, 34. More specifically, the first end 64 of the first outer section 36 is adjacent to the first fairing bar 32 and the second end 66 is adjacent to the second fairing bar 34.

Similar to the first outer section 36, the second outer section 38 has a generally arch-shaped cross section. The sidewalls of the second outer section 38 include an outer wall 68, an inner wall 70, a first sidewall 72 and a second sidewall 74. The first sidewall 72 includes a second female dovetail attachment 76 for engagement with the center section 40. The outer and inner walls 68, 70 each abut the first sidewall 72 and the second sidewall 74 but do not abut each other. Further, the second outer section 38 has a first end 78 and a second end 80. Both the first and second ends 78, 80 abut the outer wall 68, the inner wall 70, the first sidewall 72 and the second sidewall 74. There is a notched area 82 in the inner wall 70 of the center section 40 near the first end 78. Further, the second outer section 38 has a tapered contour. In other words, the second end 80 has a larger cross sectional area than the first end 78 of the second outer section 38. It can be appreciated that, in general, fan duct contours, to which the mandrel is designed, have an entrance that is larger than the fan duct exit, or nozzle end.

When the mandrel 30 is assembled, the second outer section 38 is positioned between and attached to the first fairing bar 32 and the second fairing bar 34. The arch shape of the second outer section 38 generally aligns with the arch shape of the first and second fairing bars 32, 34. More specifically, the first end 78 of the second outer section 38 is adjacent to the first fairing bar 32 and the second end 80 is adjacent to the second fairing bar 34.

The center section 40 has a generally arch-shaped cross section. The sidewalls of the center section 40 include an outer wall 84, an inner wall 86, a first sidewall 88 and a second sidewall 90. The first sidewall 88 includes a first male dovetail attachment 92 for engagement with the first outer section 36 second sidewall dovetail attachment 62. The center section second sidewall 90 includes a second male dovetail attachment 94 for engagement with the mating dovetail attachment 76 located on the second outer section first sidewall 72. The center section outer and inner walls 84, 86 each abut the first sidewall 88 and the second sidewall 90 but do not abut each other. Further, the center section 40 has a first end 96 and a second end 98. Both the first and second ends 96, 98 abut the outer wall 84, the inner wall 86, the first sidewall 88 and the second sidewall 90. There is a notched area 100 in the inner wall 86 of the center section 40 near the first end 96. Further, the center section 40 has a tapered contour. In other words, the second end 98 has a larger cross sectional area than the first end 96 of the center section 40. It can be appreciated, that in general, fan duct contours, to which the mandrel is designed, have an entrance that is larger than the fan duct exit, or nozzle end.

When the mandrel 30 is assembled, the center section 40 is positioned between the first fairing bar 32 and the second fairing bar 34. The arch shape of the center section 40 generally aligns with the arch shape of the first and second fairing bars 32, 34. More specifically, the first end 96 of the center section 40 is adjacent to the first fairing bar 32 and the second end 98 is adjacent to the second fairing bar 34. The first sidewall 88 is attached to the first outer section 36 and the second sidewall 90 is attached to the second outer section 38.

The nozzle section 42 is positioned adjacent to the first outer section notched area 67, the center section notched area 100 and the second outer section notched area 82. The tilting plate assembly 46 includes a raised plate 102 upon which the first fairing bar 32 is attached and a lower plate 103. The raised plate 102 and the lower plate 103 are connected by spacers 107.

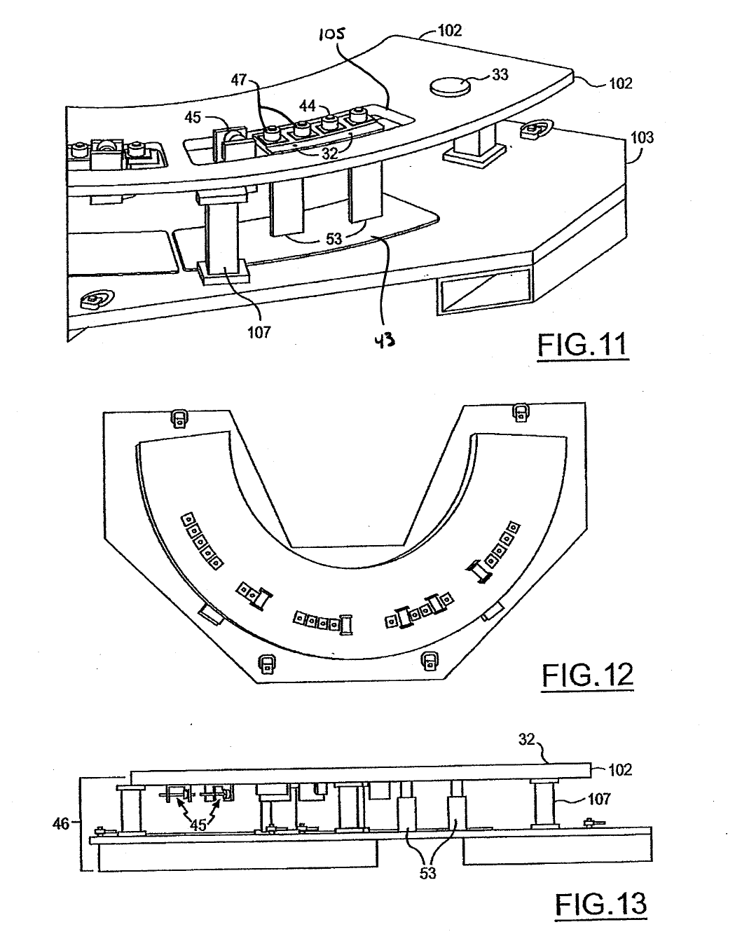

Referring to FIGS. 5 and 10-13, the ball roller assemblies 44 include at least one drive mechanism 45 and multiple ball rollers 47 (see FIG. 11) that work in conjunction during the disassembly process to slide the first and second outer sections 36 and 38 toward where the center section 40 had been positioned. The drive mechanism 45 and its associated rollers 47 protrude through the aligned apertures 50 (FIG. 4) in the first fairing bar 32 and the apertures 105 (FIG. 11) in the raised tilting plate 102. Further, the ball roller assemblies 44 are aligned relative to one another such that as each outer section, moving one at a time, rotates off of one ball roller assembly 44 it is picked up by the next ball roller assembly 44.

FIG. 10 illustrates a roller ball track plate 49 on the outer section first ends that engages the ball roller assemblies 44. There is one roller ball track plate 49 that is attached to the first outer section first end 64 and there is one roller ball track plate 49 that is attached to the second outer section first end 78. The plate 49 is generally arch-shaped to fit on the arched cross section of the outer sections of the mandrel 30. A groove 51 runs along the length of the plate 49. The groove 51 receives the drive mechanism 45 and the ball rollers 47. The plate 49 could be attached to the outer section by a number of different methods including, but not limited to, bolting them together. In an alternative embodiment, the plate 49 is integral with the first end 64 of the outer section 36.

Referring to FIGS. 5, 11 and 13, the ball rollers 47 are attached to a platform 43. The platform 43 is attached to at least one hydraulic jack 53 that lifts the ball rollers 47 into their appropriate position within the aligned apertures 105 (FIG. 11) of the raised plate 102 and the apertures 50 (FIG. 4) of the first fairing bar 32. The hydraulic jacks 53 are also attached to the tilting plate assembly lower plate 103. Each drive mechanism 45 is directly attached to the tilting plate assembly raised plate 102.

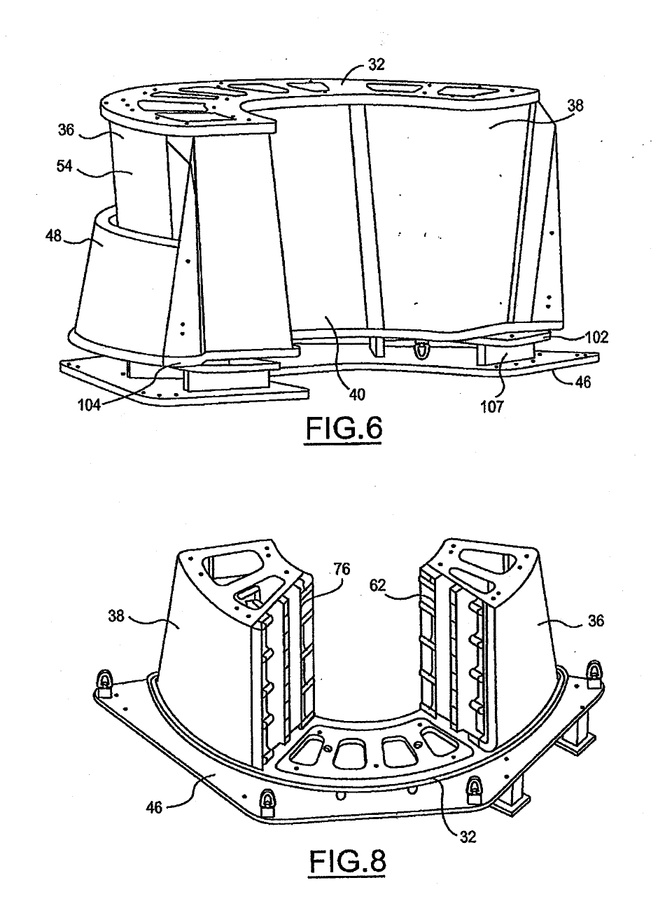

The mandrel 30 also includes a cavity section 48 (FIG. 4) that is positioned adjacent to the outer walls 54, 84, 68 (FIGS. 2 and 6) of the first outer section 36, the center section 40, and the second outer section 38 in the assembled mandrel 30. In one embodiment, the cavity section 48 is attached to the second fairing bar 32. In an alternative embodiment, illustrated in FIG. 6, there is a third fairing bar 104 that is wider than the second fairing bar 34 and replaces the second fairing bar 34 during the lay-up procedure of the part. The third fairing bar 104 also includes at least two radially located apertures 106.

### B. Embodiments of Methods for Constructing Mandrels

The three body sections 36, 38, and 40 can each be made using the same procedure. First the fabrication of the center section 40 will be described. In one embodiment, the mandrel 30 can be made of aluminum so as to capture the effect of thermal growth relative to the part materials. Aluminum also provides a de-molding advantage and may be less expensive. In additional embodiments, however, other materials can be used.

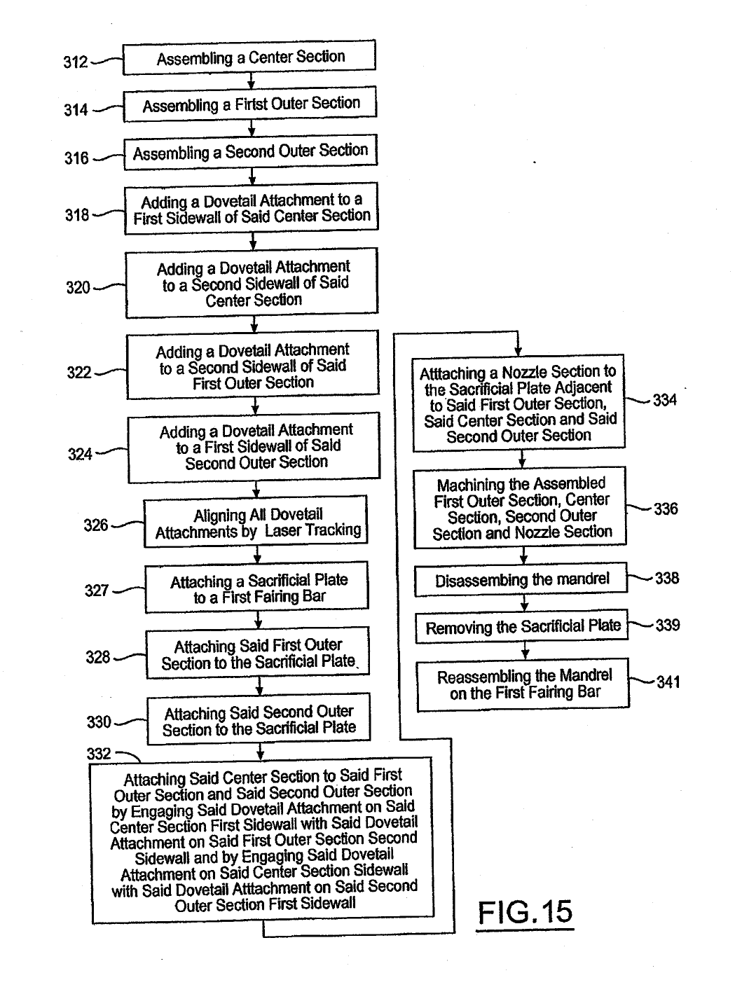

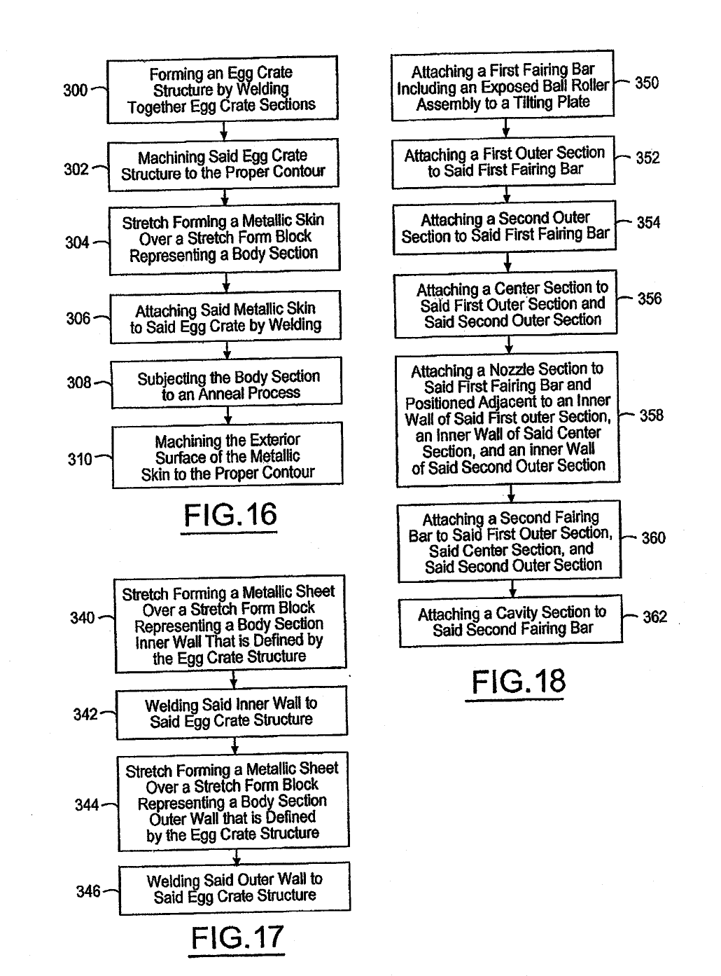

FIG. 15 illustrates one method of constructing the mandrel, and FIG. 16 illustrates one method of assembling a body section of the mandrel. Referring to FIG. 16, the center section includes a core consisting of a welded egg crate structure, 300. The egg crate is constructed or assembled using interlocking headers and intercostals. The exterior of the egg crate structure is machined to obtain the correct contour on all sides of the mandrel section, 302. More specifically, the outer area of the egg crate is machined. The piece is turned over and the inner area of the egg crate is machined.

Next, a sheet material is stretch formed over a Stretch Form Block, then placed over the egg crate structure and attached to provide a skinned surface, at 304 and 306. FIG. 17 specifically illustrates this method. There is a first sheet of material used for the outer wall and a second sheet of material used for the inner wall. For discussion purposes, the inner wall is attached first, however, it should be noted that either wall could be attached first. The first sheet of material is stretch formed and then welded to the egg crate structure, at 340 and 342. A stretch press pulls and wraps the metal around the Stretch Form Block. The sheet is trimmed to fit the egg crate. The welding equipment has exposure to the areas that require the weld due to the open nature of the egg crate and having access from the outer wall side where there is no sheet yet attached to the egg crate structure. The second sheet of material is stretch formed and then welded to the egg crate structure, at 344, 346. In order to weld the second sheet of material that forms the outer wall a slot is milled in the sheet directly over the headers and intercostals for the welding equipment to rosette weld the second sheet to the egg crate structure.

Referring back to FIG. 16, the center section then undergoes an anneal process, illustrated at 308. This process is performed to remove the internal stresses in the component. After the anneal process, the contour of the center section is rough machined, at 310. This process is then done for both the inner and outer sheets. Referring back to FIG. 15, the fabrication of all of the body sections, including the center section at 312, first outer section at 314, and the second outer section at 316, can be performed using the procedure described above.

Still referring to FIG. 15, the seams for each of the three sections are machined specifically by roughing in, then finish machining the dovetail interface surfaces for each section piece, illustrated at 318, 320, 322, 324. The dovetails are aligned and attached to each section via laser tracker, 326. The laser tracker is used to determine that all measurements and placements are precise. The center section has two sides that require the dovetail, whereas the first and second outer sections each require the dovetail on only one side. All of these steps can be performed while the component is positioned in the same shop aid holding fixture. This process is unique to this type of tool to ensure proper indexing of each tool section.

A sacrificial plate (not shown) is attached to the first fairing bar at 327. The sacrificial plate is added between the first fairing bar and the body sections of the mandrel to prevent the cutter from gouging the fairing bar during finish machining. In other words, the sacrificial plate is capable of accepting machining excess travel. The first outer section is attached to the sacrificial plate at 328. Then the second outer section is attached to the sacrificial plate, 330. The center section is then attached to the first and second outer sections by engaging the dovetail attachment on the center section first sidewall with the dovetail attachment on the first outer section second sidewall and engaging the dovetail attachment on the center second sidewall with the dovetail attachment on the second outer section first sidewall, 332. The nozzle section is attached to the sacrificial plate adjacent to the first outer section, the center section and the second outer section, 334. The assembled first outer section, center section, second outer section, and nozzle section are then fully machined, 336. After the machining, the mandrel is disassembled 338, the plate is removed 339 and the mandrel is reassembled directly on the first fairing bar 341.

### C. Embodiments of Methods for Assembling Mandrels

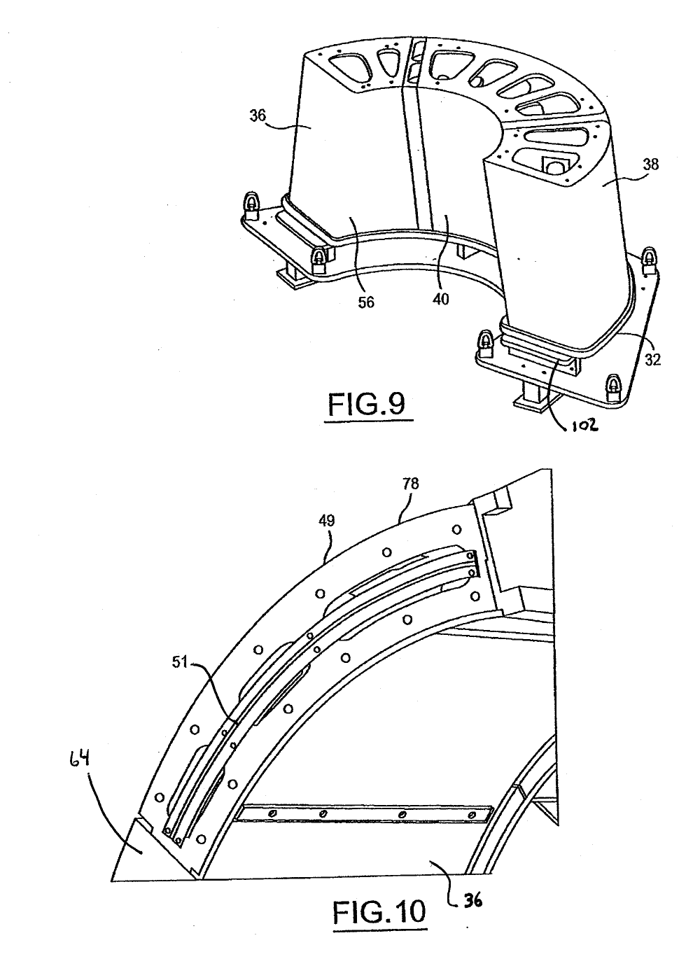

FIG. 18 illustrates one method of assembling the mandrel 30. The tilting plate is first positioned on the floor. The first fairing bar is attached to the tilting plate, at 350. This attachment may occur by bolting the first fairing bar to the tilting plate (see FIGS. 7 and 9). The first fairing bar includes the removable ball roller assembly and drive mechanism used for de-molding assistance. The ball roller assembly includes rubber wheels that are in friction contact with the section pieces to assist with the disassembly process (see FIGS. 11 and 12). Specifically, at disassembly the roller assembly and drive mechanism allow the outer sections to swing around an arc-shaped path to allow the sections to be removed from the interior of the completed part.

The first outer section is then attached to the first fairing bar, at 352. The first fairing bar includes locating pins. There are at least two locating pins 33 for each of the outer sections of the mandrel. The locating pins 33 are aligned with and receive locating apertures that are on each of the outer sections. Once located, the first outer section is bolted to the first fairing bar. The second outer section is also attached to the first fairing bar, at 354. First, the second outer section is located by aligning its locating apertures with the locating pins on the first fairing bar. Once in the proper position, the second outer section and the first fairing bar are bolted together. It should be noted that the order in which the first and second outer sections are attached to the first fairing bar does not matter. In other words, the second outer section could be attached to the first fairing bar first and the first outer section attached to the first fairing bar second.

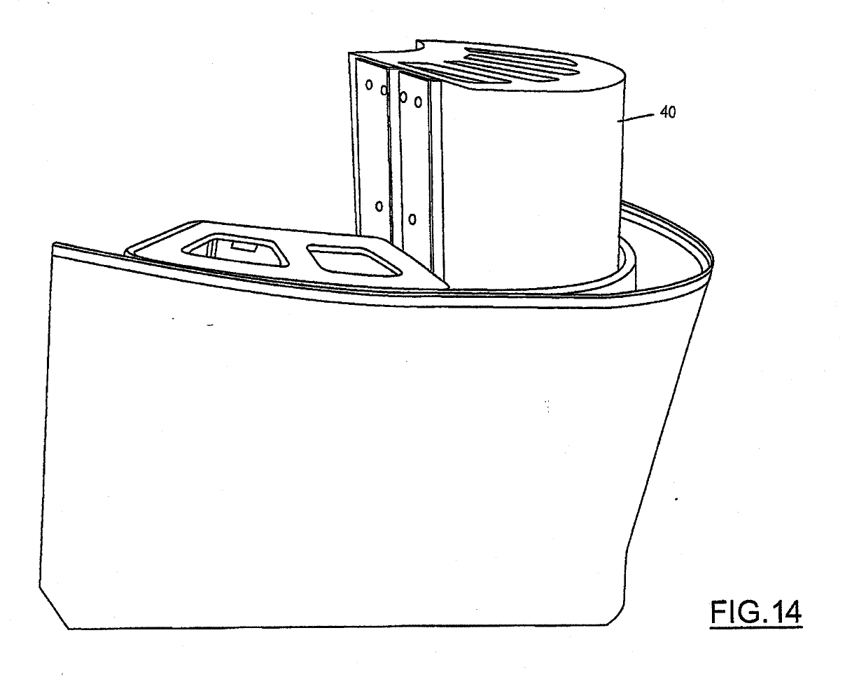

The center section is then locked into its proper position by engaging the interlocking, tapered dovetails between the three sections, at 356. The center section is lowered from above between the first outer section and the second outer section, as illustrated in FIG. 14. The first dovetail on the center section engages the first outer section dovetail and the second dovetail on the center section engages the second outer section dovetail. The dovetail geometry is specifically designed to be double tapered, transitioning to parallel features engaging in the last one-inch of travel, so as to create free travel, and final, positive engagement. The three sections lock together during the last one-inch of vertical travel of the center section. All three sections lock together via the precise matching of the dovetails as described above. The three sections are each tapered and the inherent shape of the dovetail is tapered. Due to this geometry, the three sections pull together and lock into the correct position relative to each other. Also, the tapered geometry allows for clearance in the disassembly stage. The illustrated three sections of the mandrel can be individually bolted to the first fairing bar, and may not be bolted together. Therefore, even though the sections are locked together via the dovetail attachment, this attachment is not strong enough to support its own weight. However, once the sections are bolted to the fairing bar the mandrel is sturdy enough to be maneuvered and not fall apart.

The nozzle section is then attached to the first fairing bar, at 358. In one embodiment, the nozzle section is bolted to the first fairing bar. In another embodiment, the nozzle section is integral to or permanently attached to the first fairing bar. In the embodiment where the nozzle section is a separate component, the nozzle section is positioned adjacent to the inner wall of the first outer section, the inner wall of the center section and the inner wall of the second outer section.

The second fairing bar is attached to the three sections of the mandrel, at 360. When completely assembled there is no need for vacuum tight seals between the first outer section, the center section and the second outer section, or anywhere along the length of the dovetail interface. Vacuum integrity is achieved by seals 35 designed into the end of each fairing bar assembly, as illustrated in FIG. 5. The seal locations in the end fairing bars surround end openings used for weld access, in each end of the center and outer section pieces. Location is preserved using indexing features common to both the fairing bar end pieces and the segmented mandrel pieces. Vacuum ports located in the end fairing bars allow for air to be evacuated from the part. The fairing bar shape and geometry, in addition to lending structural integrity and deflection resistance, also assists in the creation of the vacuum bag for part cure, allowing the bag to be built spanning from one end fairing bar to the other.

After assembly, the mandrel is in condition to begin the lay-up procedure for constructing a portion of the thrust reverser. The portion of the thrust reverser fabricated with the aid of the mandrel can be fabricated in multiple stages. As a result, there is a first mandrel used and a second mandrel used in the lay-up process. During the lay-up of the nacelle, once the cavity section is attached to the third fairing bar, shown at 362, it is referred to as the second mandrel.

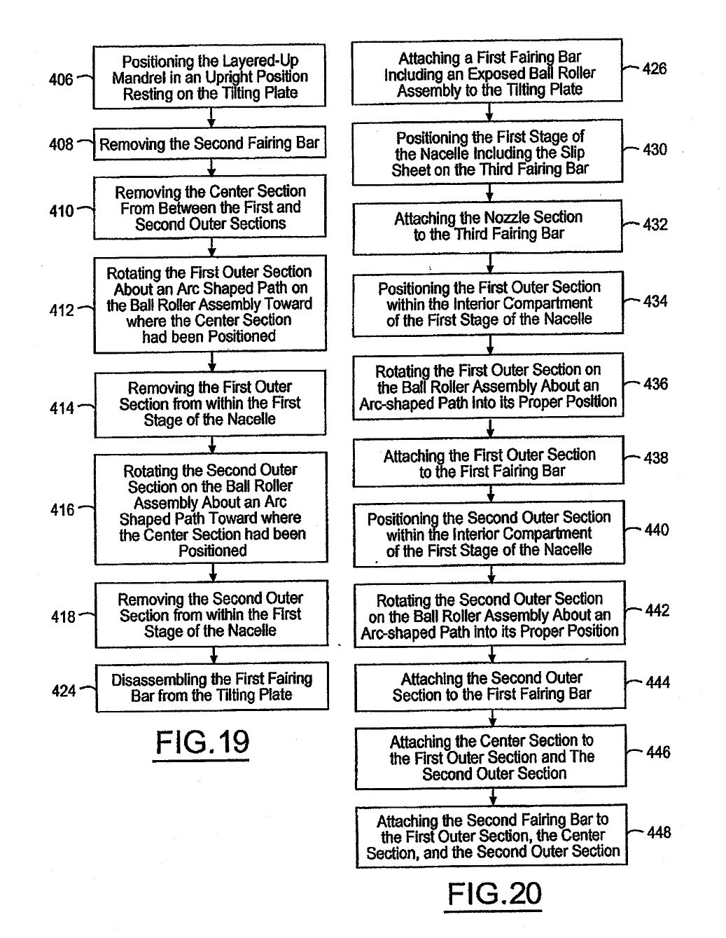

FIG. 19 illustrates one method of dissembling the first mandrel. This stage of the process is executed by standing the entire assemblage on the tilting plate so that it is in a vertical position, at 406. The second fairing bar is unbolted and removed, at 408. Then the center section of the mandrel is disengaged by being lifted from above and pulled out from between the first outer section and the second outer section, at 410. This is also illustrated in FIG. 14. The first outer section is then rotated on the ball roller assembly and travels in an arc-shaped path to provide clearance so that it can be lifted out from the center of the fan duct part, at 412 and 414. Once the first outer section is removed, the second outer section is also rotated on the ball roller assembly about an arc-shaped path so that it can be lifted out from the center of the fan duct part, at 416 and 418. Either of the first and second outer sections can be removed first. The first stage of the part can be removed from the first fairing bar after removing all three sections of the mandrel. Next, the second stage of the part can be fabricated. Due to the taper in the shape of the thrust reverser, the tool may be slipped inside of the part.

FIG. 20 illustrates one method of assembling the second mandrel. The second fairing bar is replaced with a third fairing bar, at 424. However, it should be noted that in one embodiment the second fairing bar could be reused at this stage if it is large enough to accommodate the cavity section. This third fairing bar is larger than the second fairing bar to accommodate attachment of a cavity section. The first fairing bar is attached to the tilting plate. The first stage of the part is then positioned on the first fairing bar, at 430. The nozzle section is attached to the first fairing bar, at 432. The first and second outer sections are separately lowered down into position within the part. Each is rotated about an arc-shaped path defined by the ball roller assembly into its final position, as shown at 434, 436, 440, and 442. There is no particular order in which the first and second outer sections are put into their positions. Once located into their appropriate positions, the first and second outer sections are attached to the first fairing bar, at 438, 444.

The center section is lowered into its proper position by engaging the dovetails of the first and second outer sections, at 446. The three sections of the mandrel lock into place during the last one-inch of vertical travel of the center section. The second or third fairing bar, whichever is being used as part of the second mandrel, is attached to the assembled mandrel, at 448. As illustrated in FIG. 18 and previously discussed, the cavity section is attached to the third fairing bar, at 362. Bagging plugs are installed at strategically located positions. The bagging plugs help to make a smooth transition and fair the bag so that the bag is not expected to break during curing.

### D. Embodiments of Methods for Disassembling Mandrels

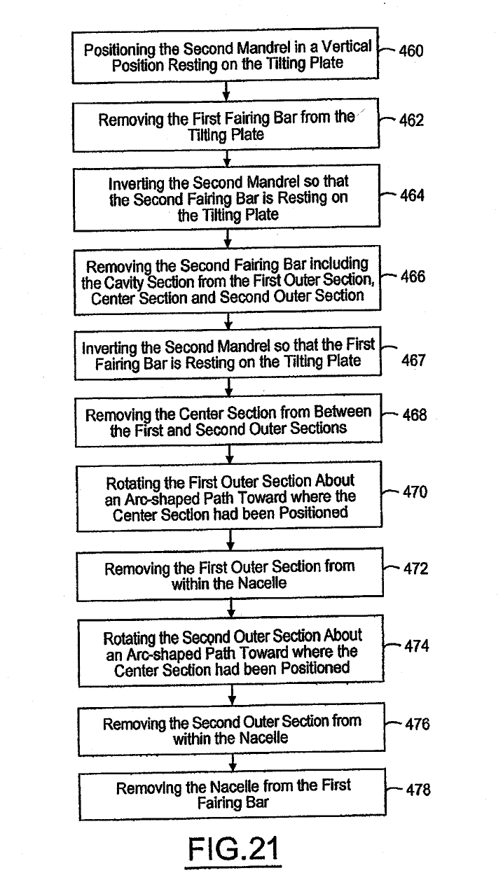

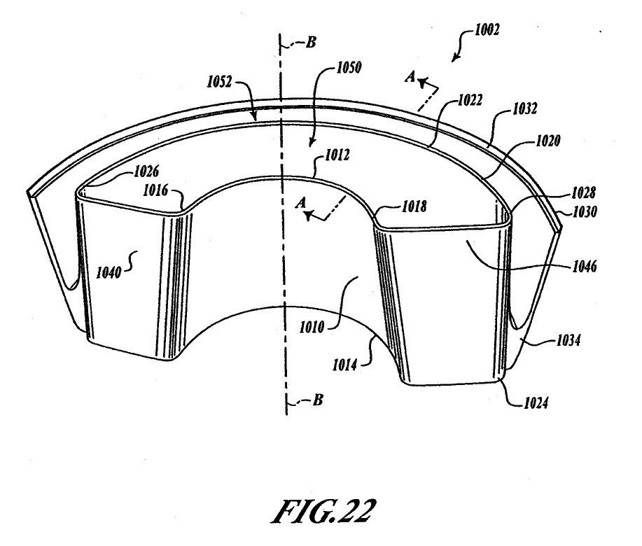

FIG. 21 illustrates one method of disassembling the second mandrel. The first fairing bar is removed from the tilting plate and the second mandrel is inverted. Then, the second mandrel is placed in a vertical position with the third fairing bar down resting on the tilting plate, at 460. The final air duct part is pulled off of the cavity section, at 462. The component is inverted again and the tool disassembly begins, at 464. The second mandrel is placed in a vertical position resting on the first fairing bar, at 466. Then, the center section of the mandrel is removed from its position within the part, at 468. Then each outer section is individually removed from its position within the part. The first outer section is rotated about an arc-shaped path as defined by the ball roller assembly and drive mechanism, at 470. The first outer section is then pulled out vertically from within the part, at 472. Similarly, the second outer section is rotated about the arc-shaped path as defined by the ball roller assembly and drive mechanism, at 474. Then the second outer section is pulled out vertically from within the part, at 476. Once the three sections of the mandrel are removed the part or nacelle can be removed from the first fairing bar, as illustrated at 478.

### E. Embodiments of Thrust Reverser Components

FIGS. 22-25B illustrate several embodiments of thrust reversers and thrust reverser components in accordance with the disclosure. The thrust reverser components can be fabricated with the specific tooling described above or with other suitable tools. Moreover, the thrust reverser components can be constructed in accordance with the methods described above or with other suitable methods.

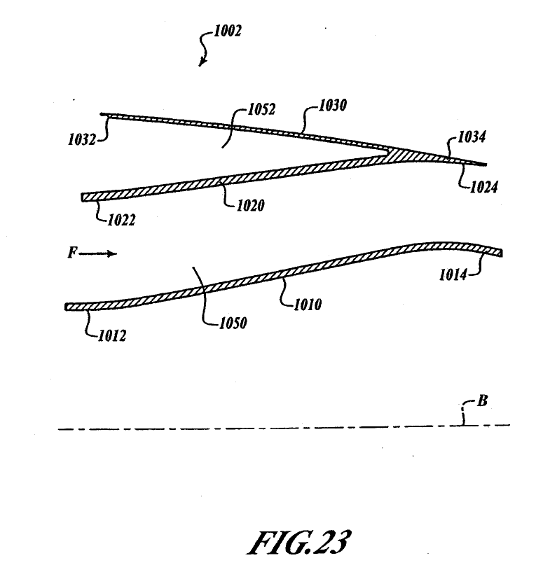

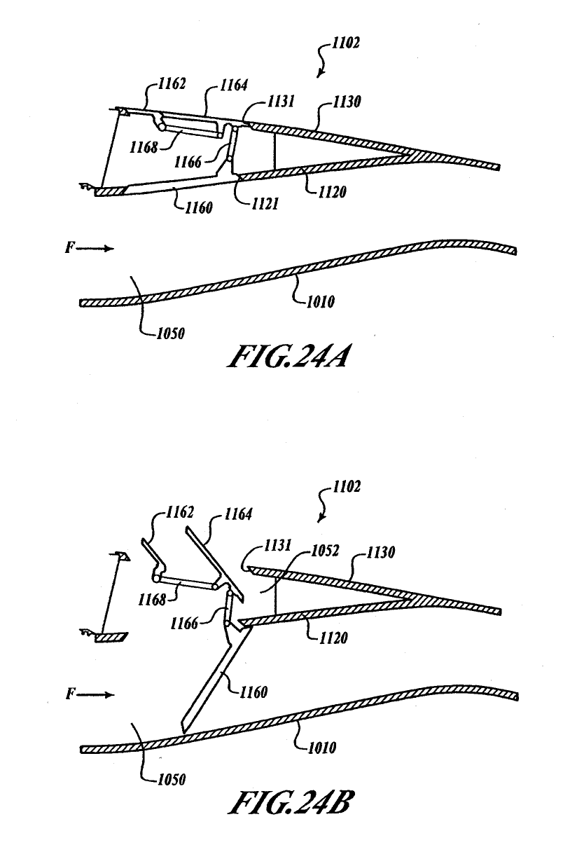

FIG. 22 is an isometric view of a thrust reverser portion 1002 in accordance with one embodiment of the disclosure. FIG. 23 is a schematic side cross-sectional view of the thrust reverser portion 1002 taken substantially along the line A-A of FIG. 22. Referring to both FIGS. 22 and 23, the illustrated thrust reverser portion 1002 includes a fan duct inner wall section 1010, a fan duct outer wall section 1020 positioned radially outward of the inner wall section 1010, a first connecting wall 1040 extending between the inner and outer wall sections 1010 and 1020, and a second connecting wall 1046 extending between the inner and outer wall sections 1010 and 1020. The fan duct inner wall section 1010 includes a forward end 1012, an aft end 1014, a first end portion 1016 (FIG. 22), and a second end portion 1018 (FIG. 22) opposite the first end portion 1016. The fan duct outer wall section 1020 includes a forward end 1022, an aft end 1024, a first end portion 1026 (FIG. 22), and a second end portion 1028 (FIG. 22) opposite the first end portion 1026. The first connecting wall 1040 extends between the first end portion 1016 of the fan duct inner wall section 1010 and the first end portion 1026 of the fan duct outer wall section 1020, and the second connecting wall 1046 extends between the second end portion 1018 of the fan duct inner wall section 1010 and the second end portion 1028 of the fan duct outer wall section 1020. The fan duct inner and outer wall sections 1010 and 1020 and the first and second connecting walls 1040 and 1046 define a fan duct portion 1050 through which fan gas flows in a direction F (FIG. 23) to produce forward thrust for an aircraft engine. The fan duct portion 1050 is positioned radially outward from a central axis B of the engine.

The thrust reverser portion 1002 further includes an outer cowling section 1030 positioned radially outward of the fan duct outer wall section 1020. The outer cowling section 1030 includes a forward end 1032 spaced apart from the forward end 1022 of the fan duct outer wall section 1020 and an aft end 1034 at the aft end 1024 of the fan duct outer wall section 1030. The outer cowling section 1030 and the fan duct outer wall section 1020 are joined and form a single wall proximate to the aft ends 1034 and 1024. Accordingly, the outer cowling section 1030 and the fan duct outer wall section 1020 define a compartment 1052. This compartment 1052 is formed by the cavity section 48 of the tool shown in FIG. 6. The outer cowling section 1030 and the fan duct outer wall section 1020 may include openings (not shown in FIGS. 22 and 23) through which a portion of the fan duct gas flow can be selectively diverted to create reverse thrust.

One feature of the thrust reverser portion 1002 illustrated in FIGS. 22 and 23 is that the fan duct inner wall section 1010, the fan duct outer wall section 1020, the outer cowling 1030, the first connecting wall 1040, and the second connecting wall 1046 constitute a monolithic member. The monolithic member is formed as a single, continuous structure and then attached to an aircraft power plant. One advantage of this feature is that the thrust reverser portion 1002 can be constructed with a single tool. This tool is expected to be less expensive to construct and operate than the multiple tools presently used to form the separate thrust reverser components in conventional thrust reversers.

In additional embodiments, the fan duct inner wall section 1010, the fan duct outer wall section 1020, and the outer cowling section 1030 may not all form part of a single monolithic member. For example, in several embodiments, the fan duct outer wall section 1020 and the outer cowling section 1030 can constitute a monolithic member, and the fan duct inner wall section 1010 can be formed separately and subsequently attached to the monolithic member. In other embodiments, the fan duct inner wall section 1010 and the fan duct outer wall section 1020 can constitute a monolithic member, and the outer cowling section 1030 can be formed separately and subsequently attached to the monolithic member.

FIG. 24A is a schematic side cross-sectional view of a thrust reverser portion 1102 in accordance with another embodiment of the disclosure. The illustrated thrust reverser portion 1102 is generally similar to the thrust reverser portion 1002 described above with reference to FIGS. 22 and 23. For example, the illustrated thrust reverser portion 1102 is a monolithic member that includes a fan duct inner wall section 1010, a fan duct outer wall section 1120 positioned radially outward of the inner wall section 1010, and an outer cowling section 1130 positioned radially outward of the outer wall section 1120. The illustrated fan duct outer wall section 1120, however, includes a first opening 1121, and the outer cowling section 1130 includes a second opening 1131 generally aligned with the first opening 1121. The illustrated thrust reverser portion 1102 further includes an inner door 1160 positioned within the first opening 1121, a forward outer door 1162 positioned within the second opening 1131, and an aft outer door 1164 positioned adjacent to the forward outer door 1162 and within the second opening 1131. The illustrated inner door 1160 is operably coupled to the aft outer door 1164 via a first link 1166, and the aft outer door 1164 is operably coupled to the forward outer door 1162 with a second link 1168. As a result, the inner door 1160, the forward outer door 1162, and the aft outer door 1164 are movable as a unit between a closed position (shown in FIG. 24A) and an open position (shown in FIG. 24B). When the inner door 1160, the forward outer door 1162, and the aft outer door 1164 are in the closed position, the fan duct inner wall section 1010 and the fan duct outer wall section 1120 direct gas aftward and produce forward thrust.

FIG. 24B is a schematic side cross-sectional view of the thrust reverser portion 1102 with the doors 1160, 1162, and 1164 open. When the inner door 1160, the forward outer door 1162, and the aft outer door 1164 are in the open position, the inner door 1160 obstructs gas flow in the fan duct portion 1050 so that a portion of the flow is diverted radially outward through the first opening 1121 in the fan duct outer wall portion 1120 and the second opening 1131 in the outer cowling section 1130. As the gas flows from the compartment 1052 and through the second opening 1131, the open forward and aft outer doors 1162 and 1164 change the direction of the gas flow to generate reverse thrust. Because the open forward and aft outer doors 1162 and 1164 redirect the gas flow to produce reverse thrust, the illustrated thrust reverser portion 1102 advantageously does not require heavy and bulky cascades in the compartment 1052. In other embodiments, however, the thrust reverser portion 1120 can include cascades and/or a different configuration of doors for obstructing the flow of gas through the fan duct portion 1050 and redirecting a portion of the gas flow radially outward to generate reverse thrust.

One feature of the thrust reverser portion 1102 illustrated in FIGS. 24A and 24B is that the outer cowling section 1130 does not translate between an open position and a closed position during operation. As a result, the thrust reverser does not require large and heavy actuators and tracks for moving the outer cowling section 1130 between the open and closed positions. An advantage of the feature is that the reduced weight and size of the thrust reverser increases the performance of the power plant.

Another feature of the thrust reverser portion 1102 illustrated in FIGS. 24A and 24B is that the portion 1102 does not include a drag link extending between the inner door 1160 and the fan duct inner wall section 1010 for opening the inner door 1160. An advantage of this feature is that the thrust reverser portion 1102 reduces the drag in the fan duct portion 1050 and therefore improves the performance of the power plant.

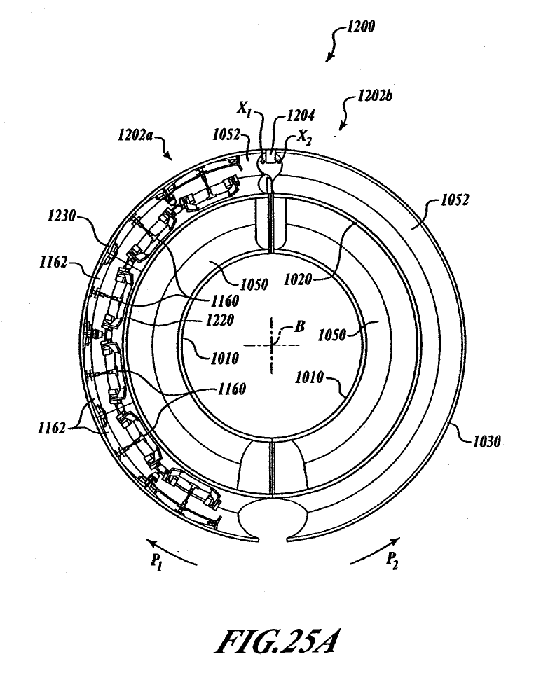

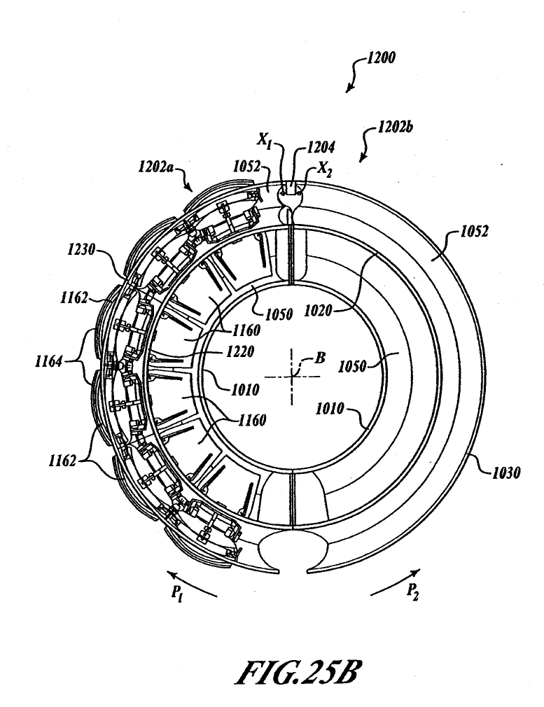

FIG. 25A is a schematic front view of a thrust reverser 1200 in accordance with one embodiment of the disclosure. The illustrated thrust reverser 1200 includes a first portion 1202a and a second portion 1202b positioned opposite the first portion 1202a. The first portion 1202a is generally similar to the portion 1102 described above with reference to FIGS. 24A and 24B. For example, the illustrated first portion 1202a includes a fan duct inner wall section 1010, a fan duct outer wall section 1220 positioned radially outward of the inner wall section 1010, and an outer cowling section 1230 positioned radially outward of the outer wall section 1220. Moreover, the illustrated first portion 1202a includes a plurality of inner doors 1160, a plurality of forward outer doors 1162, and a plurality of aft outer doors 1164 (not shown in FIG. 25A). Although the illustrated first portion 1202a includes six sets of doors, in other embodiments the first portion can have a different number of doors and/or the doors can be arranged differently.

The illustrated second portion 1202b is generally similar to the portion 1002 described above with reference to FIGS. 22 and 23. For example, the second portion 1202b includes a fan duct inner wall section 1010, a fan duct outer wall section 1020 positioned radially outward of the inner wall section 1010, and an outer cowling section 1030 positioned radially outward of the outer wall section 1020. The illustrated second portion 1202b does not include any doors, and the fan duct outer wall section 1020 and the outer cowling section 1030 do not include any openings through which fan gas can pass. In several applications, the thrust reverser 1200 may be positioned such that the second portion 1202b faces the fuselage of the aircraft. In additional embodiments, the second portion 1202b may further include one or more openings and doors for selectively redirecting the flow of fan gas radially outward.

In one aspect of the illustrated embodiment, the first and second portions 1202a-b are pivotally coupled to a pylon 1204 (shown schematically) or other support member. Accordingly, the first portion 1202a can pivot in a direction P₁ about a first axis X₁ from a closed position (shown in FIG. 25A) to an open position (not shown), and the second portion 1202b can pivot in a direction P₂ about a second axis X₂ from a closed position (shown in FIG. 25A) to an open position (not shown). The first and second portions 1202a-b are closed during aircraft operation and can be opened for maintenance or repair of the engine.

FIG. 25B is a schematic front view of the thrust reverser 1200 illustrated in FIG. 25A with the thrust reverser 1200 deployed. When the thrust reverser 1200 is deployed, the inner doors 1160, the forward outer doors 1162, and the aft outer doors 1164 move to the open position. Specifically, the inner doors 1160 project into the first fan duct portion 1050 and obstruct gas flow through the fan duct portion 1050, and the forward and aft outer doors 1162 and 1164 project at least partially into the compartment 1052 to redirect the gas flow and generate reverse thrust.

From the foregoing, it will be appreciated that specific embodiments of the disclosure have been described herein for purposes of illustration, but that various modifications may be made without deviating from the disclosure. Furthermore, aspects of the disclosure described in the context of particular embodiments may be combined or eliminated in other embodiments. Further, while advantages associated with certain embodiments of the disclosure have been described in the context of those embodiments, other embodiments may also exhibit such advantages, and not all embodiments need necessarily exhibit such advantages to fall within the scope of the disclosure. Accordingly, embodiments of the disclosure are not limited, except as by the appended claims.

1. An aircraft system, comprising a thrust reverser including:
a fan duct inner wall section;
a fan duct outer wall section radially outward of the fan duct inner wall section; and p1 a connecting wall section extending between the fan duct inner wall section and the fan duct outer wall section;
wherein the fan duct inner wall section, the fan duct outer wall section, and the connecting wall section form a monolithic member.

2. The aircraft system of claim 1 wherein:
the fan duct inner wall section includes a forward portion, an aft portion opposite the forward portion, a first end portion extending between the forward and aft portions, and a second end portion opposite the first end portion and extending between the forward and aft portions;
the fan duct outer wall section includes a forward portion, an aft portion opposite the forward portion, a first end portion extending between the forward and aft portions, and a second end portion opposite the first end portion and extending between the forward and aft portions;
the connecting wall section includes a first connecting wall section extending between the first end portion of the fan duct inner wall section and the first end portion of the fan duct outer wall section;
the thrust reverser further comprises (a) a second connecting wall section extending between the second end portion of the fan duct inner wall section and the second end portion of the fan duct outer wall section, and (b) a non-translating outer cowling section radially outward of the fan duct outer wall section;
the fan duct inner wall section, the fan duct outer wall section, the first connecting wall section, and the second connecting wall section define a first fan duct portion for receiving a fan duct gas flow;
the non-translating outer cowling section, the fan duct inner wall section, the fan duct outer wall section, and the first connecting wall section, and the second connecting wall section form the monolithic member; and
the thrust reverser is configured to operate (a) without a drag link extending between the fan duct inner and outer wall sections, and (b) without cascades positioned between the fan duct outer wall section and the outer cowling section.

3. The aircraft system of claim 1 wherein:
the thrust reverser further comprises an outer cowling section radially outward of the fan duct outer wall section; and
the outer cowling section, the fan duct inner wall section, the fan duct outer wall section, and the connecting wall section form the monolithic member.

4. The aircraft system of claim 1 wherein:
the thrust reverser further comprises a non-translating outer cowling section radially outward of the fan duct outer wall section; and
the non-translating outer cowling section, the fan duct inner wall section, the fan duct outer wall section, and the connecting wall section form the monolithic member.

5. The aircraft system of claim 1 wherein:
the fan duct inner wall section includes a forward portion and an aft portion opposite the forward portion;
the fan duct outer wall section includes a forward portion and an aft portion opposite the forward portion; and
the connecting wall section extends between the fan duct inner and outer wall sections at the forward and aft portions of the fan duct inner and outer wall sections.

6. The aircraft system of claim 1 wherein:
the fan duct inner wall section includes a forward portion, an aft portion opposite the forward portion, a first end portion extending between the forward and aft portions, and a second end portion opposite the first end portion and extending between the forward and aft portions;
the fan duct outer wall section includes a forward portion, an aft portion opposite the forward portion, a first end portion extending between the forward and aft portions, and a second end portion opposite the first end portion and extending between the forward and aft portions;
the connecting wall section includes a first connecting wall section extending between the first end portion of the fan duct inner wall section and the first end portion of the fan duct outer wall section;
the thrust reverser further comprises a second connecting wall section extending between the second end portion of the fan duct inner wall section and the second end portion of the fan duct outer wall section; and
the fan duct inner wall section, the fan duct outer wall section, the first connecting wall section, and the second connecting wall section define a first fan duct portion for receiving a fan duct gas flow.

7. The aircraft system of claim 1 wherein:
the fan duct inner wall section includes a first fan duct inner wall section;
the fan duct outer wall section includes a first fan duct outer wall section;
the monolithic member includes a first monolithic member;
the thrust reverser further comprises a first portion and a second portion positioned proximate to the first portion and movable relative to the first portion;
the first portion comprises the first fan duct inner and outer walls;
the second portion comprises a second fan duct outer wall section and a second fan duct inner wall section radially inward of the second fan duct outer wall section; and
the second fan duct outer wall section and the second fan duct inner wall section form a second monolithic member.

8. The aircraft system of claim 1 wherein the thrust reverser is configured to operate without a drag link extending between the fan duct inner and outer wall sections.

9. The aircraft system of claim 1 wherein:
the thrust reverser further comprises an outer cowling section radially outward of the fan duct outer wall section; and
the thrust reverser is configured to operate without cascades positioned between the fan duct outer wall section and the outer cowling section.

10. The aircraft system of claim 1 wherein the monolithic member comprises a composite structure.

11. The aircraft system of claim 1 wherein the fan duct inner wall section, the fan duct outer wall section, and the connecting wall section at least partially define a fan duct portion for receiving a fan duct gas flow.

12. The aircraft system of claim 1 wherein the fan duct inner wall section, the fan duct outer wall section, and the connecting wall section form a single, continuous member.

13. The aircraft system of claim 1, further comprising:
a wing coupled to the thrust reverser;
a fuselage attached to the wing; and
a tail coupled to the fuselage.

14. An aircraft system, comprising a thrust reverser including:
a first portion having (a) a first outer cowling section, (b) a first fan duct outer wall section radially inward of the first outer cowling section, and (c) a first fan duct inner wall section radially inward of the first fan duct outer wall section, wherein the first outer cowling section, the first fan duct outer wall section, and the first fan duct inner wall section form a first monolithic member; and
a second portion positioned proximate to the first portion and movable relative to the first portion, the second portion having (a) a second outer cowling section, (b) a second fan duct outer wall section radially inward of the second outer cowling section, and (c) a second fan duct inner wall section radially inward of the second fan duct outer wall section, wherein the second outer cowling section, the second fan duct outer wall section, and the second fan duct inner wall section form a second monolithic member.

15. The aircraft system of claim 14 wherein:
the first outer cowling section comprises a first non-translating outer cowling section; and
the second outer cowling section comprises a second non-translating outer cowling section.

16. The aircraft system of claim 14 wherein:
the first portion further comprises (a) a first connecting wall section extending between the first fan duct inner and outer wall sections, and (b) a second connecting wall section extending between the first fan duct inner and outer wall sections, the first connecting wall section being spaced apart from the second connecting wall section;
the first fan duct inner wall section, the first fan duct outer wall section, the first connecting wall section, and the second connecting wall section define a first fan duct portion;
the second portion further comprises (a) a third connecting wall section extending between the second fan duct inner and outer wall sections, and (b) a fourth connecting wall section extending between the second fan duct inner and outer wall sections, the third connecting wall section being spaced apart from the fourth connecting wall section; and
the second fan duct inner wall section, the second fan duct outer wall section, the third connecting wall section, and the fourth connecting wall section define a second fan duct portion.

17. The aircraft system of claim 14 wherein the thrust reverser is configured to operate without a drag link extending between the first fan duct inner and outer wall sections.

18. The aircraft system of claim 14 wherein the thrust reverser is configured to operate without cascades positioned between the first fan duct outer wall section and the first outer cowling section.

19. An aircraft system, comprising a thrust reverser including:
a non-translating outer cowling section; and
a fan duct outer wall section radially inward of the non-translating outer cowling section;
wherein the outer cowling section and the fan duct outer wall section form a monolithic member.

20. The aircraft system of claim 19 wherein:
the thrust reverser further comprises a fan duct inner wall section radially inward of the fan duct outer wall section; and
the non-translating outer cowling section, the fan duct outer wall section, and the fan duct inner wall section form the monolithic member.

21. The aircraft system of claim 19 wherein:
the thrust reverser further comprises a fan duct inner wall section radially inward of the fan duct outer wall section; and
the thrust reverser is configured to operate without a drag link extending between the fan duct inner wall section and the fan duct outer wall section.

22. The aircraft system of claim 19 wherein the thrust reverser is configured to operate without cascades positioned between the fan duct outer wall section and the non-translating outer cowling section.

23. The aircraft system of claim 19 wherein the non-translating outer cowling section and the fan duct outer wall section define a compartment.

24. The aircraft system of claim 19 wherein:
the fan duct outer wall section includes a first fan duct outer wall section;
the non-translating outer cowling section includes a first non-translating outer cowling section;
the monolithic member includes a first monolithic member;
the thrust reverser further comprises a first portion and a second portion positioned proximate to the first portion and movable relative to the first portion;
the first portion comprises the first fan duct outer wall section and the first non-translating outer cowling section;
the second portion comprises a second fan duct outer wall section and a second non-translating outer cowling section radially outward of the second fan duct outer wall section; and
the second fan duct outer wall section and the second non-translating outer cowling section form a second monolithic member.

25. The aircraft system of claim 19 wherein the monolithic member comprises a composite structure.
